(19) United States
(12) Patent Application Publication
(10) Pub. No.: US 2006/0103130 A1
(43) Pub. Date: May 18, 2006

(54) Method, system and package for specifying products to be sold

(76) Inventors: Pekka Koivukunnas, Jarvenpaa (FI); Jani-Mikael Kuusisto, Pirkkala (FI)

Correspondence Address: VENABLE LLP, P.O. BOX 34385, WASHINGTON, DC, 20045-9998, US

(21) Appl. No.: 10/986,756

(22) Filed: Nov. 12, 2004

(51) Int. Cl. B42D 15/00

(52) U.S. Cl. 283/81

(57) ABSTRACT

A method for specifying products to be sold, in which a plurality of mutually substantially identical products and/or their packages are equipped each with an optical diffraction element of its own. The element gives the same visual impression in each product or its package. In addition to the product and/or its package, the material relating to the distribution or sales of the product is also equipped with an optical diffraction element giving the same visual impression as the optical diffraction element on the product or its package. The material may also be equipped with an element simulating this visual impression.

### FIELD OF THE INVENTION

The present invention relates to a method for specifying products to be sold or marketed, in which a plurality of mutually substantially identical products or their packages are provided each with an optical diffraction element of its own, which on separate products or their packages gives the same visual impression. The invention also relates to a system for specifying products to be sold. The object of the invention is also a recognizable package containing at least one product, and a product made recognizable.

For specifying (identifying) products on the market, it has been customary to use trademarks whose purpose is to distinguish products of a given manufacturer from products of the same kind originating from other manufacturers. Visual trademarks help to strengthen the image of the product, and they are important in creating a “brand”. Counterfeit products, that is “piratism”, have become a problem for the manufacturers of branded products, which poses a problem to the consumer as well, who should be able to rely on the fact that a product that is marked with a certain distinctive sign is authentic, if his/her purpose is to acquire a product of known origin and quality. The invention also relates to a method for helping consumers to recognize authentic products.

### BACKGROUND OF THE INVENTION

Many methods for verifying the authenticity or genuinity of products have been in use. The methods can be roughly divided to those intended for the public and those intended to be accomplished by experts equipped with special devices. The former ones can be based on direct observations by human senses, whereas the latter ones require knowledge and special accessories. Both types can utilize diffraction optics for specifying the product, which means that the product is provided with an optical diffraction element containing an identifier (indication) which can be either immediately recognized visually or which requires accessories. Document WO 01/94698 (Avantone Oy) describes such elements which can be formed on a packaging material of paper or cardboard by embossing. Further, a method is known for forming an optical, immediately visually perceivable optical diffraction element directly on an item, such as an orally administrable product, as is disclosed in documents WO 03/005839 and U.S. Pat. No. 4,668,523 (Begleiter, E).

Further, U.S. Patent Application Publication 2002/0047262 (S. Vesborg) discusses molding holographic images directly onto packaging for products, to make the hologram as an integral part of the package which can be any enclosure, such as a container, bottle, box or dispenser. The shim that carries the holographic image is secured into a mold before molding the package from plastics which can be thermoplastic or thermoset plastics. This publication concentrates exclusively on packages.

Finally, U.S. Patent Application Publication 2004/0045204 (Miano, R. and Holerca, R.) disclose a holographic product labeling method to provide a more eye-catching display to enhance the appeal of the product in a retail environment for example.

Although the aforementioned elements help to achieve different effects, the identifying effect of these elements has not been utilized to a full extent. The public (consumers) has not learned to use these effects to verify the origin/authenticity of the product to the same extent as other identifying data. This may be due to the fact that these elements have not been widely applicable particularly to high volume packaging and their related printed and non-print marketing communications.

### SUMMARY OF THE INVENTION

The purpose of the invention is to present a method by which consumers can be given directly visually perceivable cues by means of optical diffraction elements for purposes of product identification in the same way as more conventional identification data (e.g. use of certain brand identifying colors and inks across products and different marketing communications media). The purpose of the invention is also to hinder or at least hamper, by means of widely using optical diffraction elements to identify a brand, the activities of product counterfeiters by creating a system in which misleading marketing of a pirate product as an original product becomes impossible or at least more difficult.

For achieving the aim of the invention, the method for specifying and authenticating products is primarily characterized in that in addition to the product or its package, also the material relating to the distribution or sale of the product is equipped with an optical diffraction element giving the same visual impression as the optical diffraction element of the product or its package, or the material is equipped with an element simulating this visual impression.

The material relating to the distribution or sale of the product may be any promotional material, such as an advertisement or a product specification. The concept of promotional material may be wide, on a scale from traditional advertising establishing notoriority or reputation for the product to more informative approach giving facts and details (such as a product information, data sheet, or instructions of use). The promotional material can be physical or exist in electronic form. Physical means in this context that the promotional material is a physical object on which the element can be seen with bare eye. The object may be a printed product, wherein the optical diffraction element can be made directly on the surface of the substrate of the printed product (e.g. paper, paperboard or plastics). It may also be a transport package in which the products or their packages are transported. In the case of electronic promotional material, it may be an electronic medium (e.g. the Internet, TV), wherein the optical diffraction element is not physically transportable but it is a simulation of the visual impression of this optical diffraction element that physically exists on the product/package. The simulation is displayed on the consumer's terminal or on any terminal accessible to the public (PC, portable telecommunication terminal, TV set, movie screen). It is possible that the optical diffraction element of this kind is stored on an data carrier which may be physically movable as such (for example diskette, CD, DVD or the like).

One example of displaying an optical diffraction element in electronic medium over the Internet is shown on web page http//:www.3dag.ch/website/index.html, as accessed on Sep. 30, 2004.

Another special case is that both the product and its package are equipped with an optical diffraction element giving the same visual impression. In this case, the optical diffraction element on both the consumer product and its package, giving the same impression, intensifies its effect as an identifying means and simultaneously makes the activities of product counterfeiters more difficult. If the product and its package are equipped with such an element, the element giving the same visual impression or simulating this impression can also be used in material used for its distribution or sales, which is usually distributed and displayed to consumers consumers separately from the package and product.

Still another special case is that the product contains optical diffraction elements in at least two physically discrete portions which may be separable from each other in the product or intended to be attached to each other permanently during the use of the product. An example is a consumer product having one diffraction element on the surface of one material (such as surface of a bottle or other container) and another diffraction element of identical visual impression on the surface of another material in the same product (such as on a cap of a bottle or closing element of a container of any kind, or on a label attached to a bottle or container).

According to a particularly preferred embodiment, when the promotional material (incl. advertisements, product specifications or the like), is on a physical carrier such as paper or cardboard or plastic, the optical diffraction element is formed directly on the surface of this carrier (substrate), using its surface material which may be the composition of the body of the carrier material itself (for example plastic) or which, especially in the case of paper or cardboard but also in case of a plastic body, may have a top layer suitable for forming the element directly, such as a coating paste, size, resin, extrusion coating, surface lacquer or printing ink which can be processed to create a microstructure forming the optical diffraction element, for example by embossing. Likewise, if a product label is one of the above-mentioned materials the optical diffraction element can be formed directly on its surface in an analogical manner. Further, all kinds of packaging materials that are of the above-mentioned materials and may have any of the above-mentioned surface materials can be used as a substrate for directly forming the optical diffraction element on the substrate, preferably by embossing. The packaging material can also be flexible packaging material made of any of the above-mentioned materials, and the material can form a surface which can be processed by embossing to form an optical diffraction element directly on it. As to materials and methods for creating the optical diffraction element, identifiable by bare eye, on any of these substrates by working the surface, reference is made to US published patent application 2003/0173046 or the corresponding, above-mentioned document WO 01/94698, which are incorporated herein by reference.

Promotional material serving as carrier of the optical diffraction element contains print as a result of a printing process in the form of a visible impression on a surface. The optical diffraction element is visible on the surface of the promotional material together with this print, which may contain features serving to distinguish the product, such as trademark, figure, special background color, special combination of colors, or the like. Likewise, any packaging material serving as carrier of the optical diffraction element may contain and preferably contains print as a result of a conventional printing process in the form of a visible impression on a surface, which may contain similar features for product identification as the promotional material in any graphic form, such as trademark, figure, special background color, special combination of colors, or the like. The optical diffraction element is visible on the surface of the packaging material together with this distinctive print.

By forming the diffraction element directly on the substrate, separate tags carrying only these elements can be avoided (fully or in part), which greatly increases the production rate of these elements on any kind of printed matter, because the processing of the diffractive elements directly on the surface can be integrated in the printing process or run effectively as an off-line process. This makes a mass production of the optical diffraction elements serving as authentication means possible, which also helps to exhaust the resources of potential counterfeiters, especially if the optical diffraction element can be placed directly on two substrates of different kind but related to the same product.

In general, the aim is to strengthen the identity of the product by means of the same effect that is present in at least two different locations and is immediately visually recognizable. By selecting the locations of the effect and the number of its duplicates it is also possible to hinder the activities of product counterfeiters. An optical diffraction element, which is visually directly detectable, refers to an element giving an effect which can be detected by the eye under normal illumination conditions from at least some angle of view; that is, an element which can be easily noticed by the consumer on the product, on its sales package, on the transport package of products or their sales packages, or on other printed matter relating to the sales or manufacture of the product which will be described in more detail later.

### BRIEF DESCRIPTION OF THE DRAWINGS

In the following description, the invention will be described in more detail with reference to the appended drawings, in which

FIG. 1 shows a package according to the invention,

FIG. 2 shows the placement of packages according to FIG. 1 in another package,

FIG. 3 shows another package according to the invention,

FIG. 4 illustrates material related to the distribution or sales of the product,

FIG. 5 illustrates material of another type,

FIGS. 6a-c illustrate the forming of an optical diffraction element directly onto any substrate,

FIG. 7 is an example of a product according to the invention,

FIG. 8 is an example of a package and product according to the invention,

FIG. 9 is another example of a package and product according to the invention, and

FIG. 10 illustrates schematically and in a simplified manner the route of products from a producer to consumers in accordance with the present invention.

### DETAILED DESCRIPTION OF THE PREFERRED EMBODIMENTS

In FIG. 1, a product is indicated with a reference sign A. The product is a single consumer article which is the smallest unit used by the consumer either at one time or repeatedly. In the case of FIG. 1, the product is a container (bottle) which contains a substance and from which the substance is dosed repeatedly (at intervals). Examples to be mentioned include cosmetics or toiletries, such as bottles of shampoo, perfume, etc. It is characteristic of the container of this kind that it contains material that can not be marked by any graphic signs but the container forms the first surface which can be provided with a distinctive graphic sign. Although the container is a sort of package for the material (called “primary package” in packaging technology), in this context it is a product since it forms a compact unit that a consumer uses for his/her purposes without separating it in several parts (a consumer article). The consumable material inside the container is material that is typically measured in volumetric or weight quantities, and it can be caseous, liquid, pasty, gel-like, consisting of solid particles, or a mixture of two phases. The material can be food or non-food material.

A visually directly detectable optical diffraction element E is provided on the surface of the product A. In the figure, it is provided on a label attached to the surface of the container. The element E can also be formed directly on the surface of the container, if it is made of a suitable material (for example cardboard having suitable top coating, or plastics). In general, the element E can be provided on the surface of the product A in a variety of ways, either by utilizing the material properties of the product A, wherein the element can be made directly by embossing on the surface of the product A, or by forming the element E on a separate substrate which is attached to the surface of the product A or which has been attached to the surface before forming the element E. In this case, the material properties of the separate substrate may be more suitable than those of the surface of the product A itself. As an example, it is possible to mention a label containing other graphic indicia on it, such as the product information (trademark etc.) and the element E, the label being attached to the surface of a glass container, for example a glass bottle. The diffraction elements can be formed directly on the label material by embossing which can be integrated in the printing process of labels where they are equipped with other graphic indicia, for example of alphanumeric nature, (text), such as product information.

FIG. 1 shows a cross-section of a package P1 (called “secondary package” in packaging technology, in this context product package), inside which the product A (a primary package in packaging technology terminology) equipped with the element E is placed. The surface of the package is equipped with a visually directly detectable optical diffraction element E giving the same visual impression as the element of the product A. The same material requirements and alternatives are suitable for arranging the element E on the surface of the package P1 as for arranging the element E on the surface of the product A. If the package is made of cardboard, the element E can be formed directly by embossing on the surface of the package P1, if the package board has a suitable coating. Even though the product A shown in the package is a container described above, it could be any other product (consumer article) provided with an optical diffraction element. The package contains print formed in a printing process that identifies the product inside the package to the consumer, and it may be in any graphic form, including colors, text, signs, figures, which at the same time may have a function of a trademark.

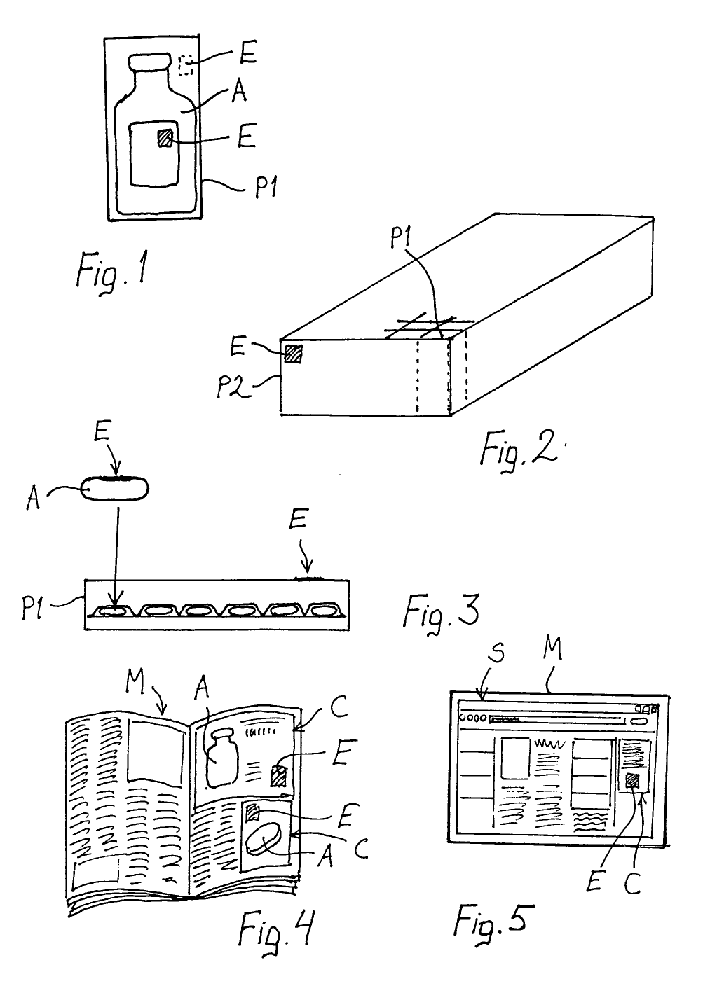

FIG. 2 illustrates the way in which several product packages P1 are placed in a larger transport package P2. This is an example of a material relating to the distribution or sales of the product A, which material is also equipped with a visually directly detectable optical diffraction element E giving the same visual impression as the element E on the product A and on its package P1. For the placement of the element E in the transport package, the same conditions apply as for its placement in the product package P1. The transport package P2 may be left as a display and storage package for sale of the products in a shop so that the element E on it is visible for consumers. The transport package may contain print visible on ist surface, identifying the products inside the transport package.

FIG. 3 shows another kind of a product and package concept. In this case, there are several separately markable products A in the same product package P1, which is the smallest unit to be sold to a consumer. These products are countable objects and large enough and of a material that enables their marking. The products are usually measured in numbers when used and often used only one at one time. A good example, in connection with which the invention is well suited for use, is products to be administered orally, particularly pharmaceutical products. A dose of medicine in solid form (a pill, a tablet, or the like) constitutes the smallest product unit to be taken by a consumer at one time without breaking the product and made to carry a distinctive sign in the form of a visually immediately detectable optical diffraction element E, which is formed directly on the surface of each product A. The surface properties of the product, for example the coating, should have such workability that a microstructure having the desired effect can be provided e.g. by embossing. The product package may contain print visible on its surface and identifying the products inside it, with all alternatives of graphic representation presented above for packaging materials.

As to the forming of the element E giving the same impression on the product package P1 in FIG. 3, the same conditions apply as for the package P1 of a single product in FIG. 1. In FIG. 3, the products A are packed in a so-called blister package placed inside the product package P1. This interior package may also comprise a corresponding element E. This is an example how the package can consist of more than one package (ie. primary and secondary packaging in packaging technology terminology), for example an inner package and one or several outer packages. In such cases its is preferred that at least the outer or outermost package that is immediately visible to the consumer carries the optical diffraction element, and another element of the same visual impression is carried by an inner package and/or a product inside the inner package.

The package P1 of FIG. 3 is in the form of a board box, but it could be in the form of a bottle of pills, for example a bottle of plastics, which can carry the optical diffraction element formed directly on its surface or formed directly on a label attached to its surface.

A plurality of the packages P1 of FIG. 3 can also be arranged in a transport or storage package P2 according to the principle shown in FIG. 2.

The packaging material on which the diffraction element is formed may be a wrapping material or a flexible packaging material that forms a flexible pouch-like, bag-like or sachet-like package of paper or plastics for example, or boxboard material that board blanks can be cut from which are formed into boxes by folding, or any material that is designed to totally or partly surround one or several products (consumer articles).

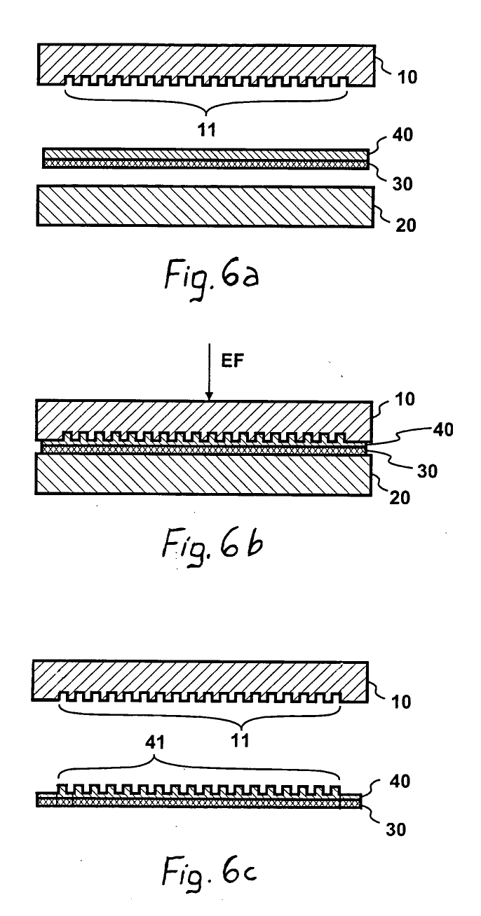

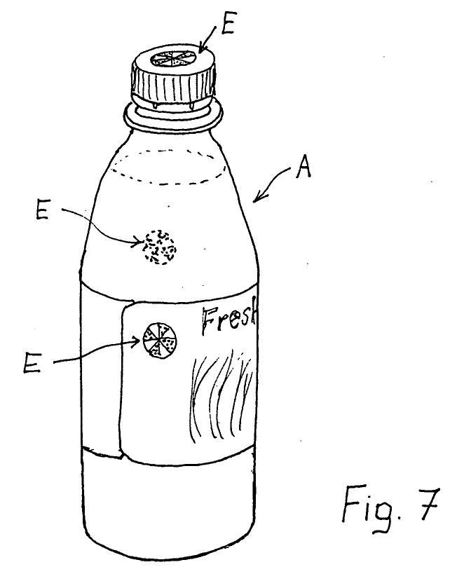

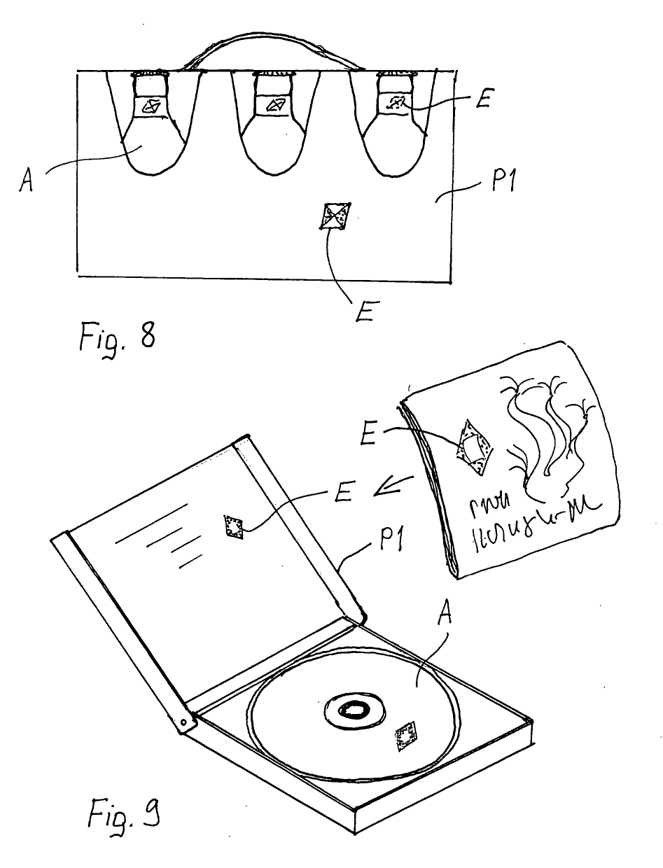

FIG. 4 illustrates the way in which the material M relating to the distribution or sales of products according to FIG. 1 or 3 can be equipped with a visually directly detectable optical diffraction element E giving the same visual impression as the element E on the product A and/or its package P1. The material is a solid substrate on which the element is arranged. The substrate may be a sales promotion material based on paper or cardboard (or a promotional package, e.g. of plastic, which is usually distributed along with other printed matter). In FIG. 4, it is more precisely a paper-based printed product (a newspaper or magazine), in which an advertisement C on one page contains said element. The printed product may also be a product brochure of one or more pages. Such a product brochure can also be used as an advertisement displayed at a retail outlet for the product. The sales promotion material may also be a poster fixed to a wall or other suitable support. In the printed product, the element E can be formed in connection with the printing, for example, by embossing by utilizing the properties of the coating or any substance added for this purpose on the surface of the printed product. The promotion material may also be combined with the product, for example inside the packaging material of the product. In this case the element will be visible only after opening the package The promotion material of this type may be product information, data sheet, instructions of use etc. The material inside the package can be in one-sheet form or in leaflet form or in any typical printed matter form.

As to the structure of the diffraction element giving a desired holographic effect and ways of forming it directly onto a printing substrate which serves as package or promotion material, reference is also made to publication WO 2004/057382, the disclosure of which is incorporated herein by reference.

According to the teaching of the above document, the optical diffraction element on a physical carrier is preferably “transparent” in the sense that it does not hide the substrate underneath, because the visual effect is perceivable only in a limited number of viewing angles. In viewing directions between these angles the substrate on which the element is formed is visible, with all possible print or markings or other details observable. Optically this is achieved for the reason that the diffraction element consisting of a grid structure is designed to produce a holographic or corresponding visual effect based on the diffraction of light by directing the light diffracted from the grid structure and corresponding to the design wavelength substantially to only a few diffraction orders. Thus, the element is arranged to leave a free range of angles between adjacent viewing directions, such that the element being examined from directions corresponding to said range of angles does not produce for the viewer a clearly discernible effect based on diffraction. If the substrate on which the element is formed is transparent and is used as packaging material (such as plastics material for flexible packages), the contents of the package are visible both through the element (in chosen viewing directions) and the substrate (packaging material). If the substrate is not transparent, the surface of the substrate, with possible printed patterns on it, is visible through the element.

The principle underlying the publication WO2004/057382, which can be applied also in the present invention, is based on the idea that a micro-optical diffractive grid structure, preferably a surface grid structure, is produced on a substrate, said grid structure being arranged to direct the visual effect (hologram) it reflects on a very limited number of different diffraction orders. One central factor in reducing the number of the diffraction orders is the selection of a sufficiently small value for the grid period. Prefereably, the visual effect is thus reflected substantially only in one, or few diffraction orders at the most, said diffraction ordes corresponding to the different observing directions of the visual effect. First, the restricted number of observing directions where the effect is visible leaves a sufficiently free range between these directions where the effect is transparent. Secondly, when the reflection of light is directed to only one or a few narrow ranges of areas, the effect is discrned brightly in these directions. Thus, it is possible to use as substrate a transparent material that does not substantially reflect light itself. Consequently, use of high reflective or high refractive index coatings on grids to create an effect that a human eye can catch is not necessary, and the forming of optical elements in direct process on a suitable substrate is well suitable for mass production. The optical diffraction element may have in its grid structure one pattern area representing one “design wavelength”, whose effect is reflected to the observing direction in corresponding color. The element may also have two or more pattern areas having the same observing direction but different design wavelengths, making said pattern areas discernible in corresponding colors. The microstructure making the effect (color(s)) visible only in limited number of observation or viewing directions creates a suitable “flashing” effect when the observer (a consumer for example) and the item carrying the optical diffraction element move in relation to each other.

All printable substrates on which the optical diffraction element E can be directly formed, be it a label, packaging material (either in the sense of outer surface of a product, or packaging material partly or totally enclosing a product), or promotion material that is distributed together with or separate from the product or package, contain, in addition to the diffraction element, other graphic indicia, which may be alphanumeric, figure elements, or both, or special colors or color combinations, and may be formed in a conventional printing process. These indicia usually serve as conventional product identification means and they are designed to give a message to consumers. If the diffraction element is transparent in the above-described way, at least part of the other graphic indicia may but need not necessarily be located underneath the optical diffractive element. The “transparency” of the diffraction element discussed above does not hide in this case the graphic indicia but it can be examined in directions corresponding to the above-mentioned free range of angles. If the printed matter is to be provided with the optical diffraction elements, the processing of the substrate surface to create the element is most preferably integrated in the printing process of the substrate.

The optical diffraction element can be formed on the same surface as the print has been formed in printing process. However, especially in packaging technology but in other graphic arts technology as well where a visible print is created on a substrate surface, the surface may be covered with a protective transparent layer. In this case the diffraction element is preferably formed directly on the protective surface layer which allows the print to remain visible underneath the diffractive element for a viewer. This is advisable if the printed surface is of difficultly embossable nature or non-embossable, or if the difference in refractive indexes of the print surface and material of the covering layer is not large enough to retain the holographic effect. Consequently, the “transparency” of the diffractive element can be created by a top layer covering any indicia on a printing substrate surface and carrying the diffractive element. The optical diffractive element E can be worked on the top layer already prior to joining the top layer to the print surface if it in this phase exists as coherent film or the like and is suitable to be embossed in that form and the joining process does not destroy the diffractive element so formed. If the effect afforded by the diffraction element is visible only in some angles, all graphic indicia directly underneath the element will be visible in other viewing angles.

It is appreciated that although the optical diffraction element may cover part of the print on the surface, graphic indicia is visible elsewhere on the surface on areas not covered by the optical diffraction element so that both the conventional print and the optical diffraction elemnt can be viewed next to each other. The purpose of the “transparency” of the optical diffraction element is thus to create the “uninterrupted” effect of the conventionally printed surface when the surface is viewed at certain angles. Hovewer, it is not outside the scope of the present invention that in forming the diffraction element, it is aligned with a selected portion of the print, such as a figure or other graphic sign, so that said selected portion will become visible underneath the optical diffraction element when viewed in said angles where the visibility is not blocked by the effect of the optical diffraction element.

It should be noted that use of protective lacquers or any other protective transparent layers on top of the optical diffraction element is not excluded in the present invention, if the material of the layer has suitable optical properties so that the effect of the element will be visible also underneath the layer.

FIG. 5 illustrates the way in which the element E can be seen in any material distributed normally separately from the product A for the purpose of sales promotion or information and containing also other information about the product A in addition to the element E. In FIG. 4, this material M was a physical carrier (any printed matter, such as a brochure, a newspaper page or a magazine page), whereas the material M in FIG. 5 is an electronic medium, the Internet being shown as an example. On the screen S of a terminal (a desktop PC or a portable PC or a portable telecommunication terminal having access to the Internet), the browser has opened a page including an advertisement C which contains, in addition to other product information, also the element E which, in this case, gives the same visual impression as the optical diffraction element E physically present on product A and/or on its package P1; in other words, the displayed element E “simulates” this optical diffraction element. In the same way, the element E can be provided on product specifications to be transmitted via electronic media. In the analog way, the element can also be simulated in television broadcasting in such a way that it also gives a similar impression on the screen of a TV set.

In the case of FIG. 5, the element E, in addition to other product information, can be stored on a recording medium (hard disk, diskette, CD, DVD etc.) in a format readable by the terminal.

FIGS. 6a, 6b and 6c show the general principle of forming of the optical diffraction element E directly onto a substrate of suitable material, be it a product, label, packaging material or promotional material. The surface of the substrate is mechanically worked with a tool, a so-called shim, corresponding to the desired grid pattern in an embossing process, which leaves the desired grid pattern on the outer surface of the substrate. This process is sometimes described as “microembossing”.

FIGS. 6a-6c show in steps schematically how the microstructure disussed above, giving the desired visual effect, is created directly on the surface of the substrate. It should be noted that the purpose of the figures are illustrative and they do not represent the true proportions of dimensions of various elements and structures. For example the substrate 30 and its surface 40 can continue well beyond the limits shown in the figures so that the microstructure is limited to a defined area on its surface.

With reference to FIG. 6a, the microstructure area 41 corresponding to the area of the optical diffractive element E is produced on the surface layer 40 of the substrate 30 by pressing the substrate 30 between an embossing member 10 and a counter member 20 so that the surface 40 of the substrate is worked with a good precision to correspond the microstructure area 11 existing on the surface of the embossing member 10.

In FIG. 6b, an embossing force EF is exerted on the embossing member 10. As a result of the embossing force, the surface of the embossing member opposite to the surface 40 of the substrate 30 further exerts embossing pressure on the material of the surface 40. The local, spatial differences in the embossing pressure cause local flow and/or compression of the material in the surface 40 of the substrate 30.

When the embossing member 10 is removed, it leaves the microstructure on the surface 40 over a certain area 41.

The surface 40 is of material that can be worked mechanically with the working member 10 to create the desired microstructure having a grid pattern that produces the optical diffractive effect. The substrate can be of this material throughout the whole thickness, in which case specific material on the surface is not needed.

FIG. 7 shows still one example of a product where the elements E of identical visual impression are on materially different portions of the product. The product is a bottle containing beverage and closed with a cap. The element E is both on the label of the bottle and on the cap. Alternatively, if the body of the bottle is of suitable material (for example plastic), the element E may be on this surface and on the cap. A third alternative is that the element E is both on the label and on the body of the bottle. The similar approach can be used in any container designed to hold a substance, which can be food or non-food type, and having a closing element which can be removed to access the contents. Consequently, the principle of FIG. 7 can be applied to many types of beverage containers intended for consumers.

FIG. 8 shows an example of a package which is used to carry several bottles at one time. The package is made of cardboard and surrounds partly the bottles so that they can be taken along by using a suitable handle construction or holes provided in the package (a so-called “wrap-around beverage carrier”). The number of bottles can be six according to the known six-pack design, but it can be less or more, for example twelve according to a recent design. The bottles can be provided with the element E in any of the ways mentioned above in FIG. 7, and the packaging material (which of course may contain conventional printing) is provided with the element E at suitable location.

The product A may have several embodiments. Feasible containers A shown in FIG. 1 and containing a substance include a bottle (for any kind of liquid or gelly or pasty substance), a tube (for example for toothpaste, cosmetic preparation, food preparation), a box (for various materials in solid form for example) or a liquid package made of board (for example, a package for liquid food such as juice), that all may contain conventional print of above-described nature for identifying the product. It is possible that such products are not packed one by one in separate product packages P1 but they are packed together in a larger transport or sales package P2. Thus, FIG. 2 can be thought to illustrate a situation in which the product packages P1 are replaced with the actual products A.

It should be noted that the concept of “product” and “package” are not mutually exclusive. As is exemplified above, the actual material to be utilized by the consumer may be of such type that it is technically impossible or economically not feasible to provide it with a distinctive marking, in which case the structure enclosing this material, although regarded as “package”, is the first surface which can be provided with a distinctive marking in the form of the optical diffraction element. Therefore, the term packaging material used above may also refer to a material being the outer surface of the product rather than package of one or several individual articles.

The products can be other than food products, pharmaceutical preparations (pills, tablets or the like), or cosmetic/hygienic products, that is, practically any product that needs authentication. The above-listed products are dispensable or edible products, but the products can be durable consumer goods for long-term use as well. One example are sound or video recordings or computer programs on a carrier, where both the single article itself (CD for example) and its casing (package) can be provided with an optical diffraction element identifying the product to be authentic. The printed matter inside this casing is an example of one further item which may also be equipped with such a distinctive element, in which case it can be directly visible through the transparent lid or cover of the casing, which in this case does not necessarily need (but may have) such a distinctive element. This example is shown in FIG. 9, where both the pivotable transparent lid has one element E (for example on the inner side of it), the recording medium inside the package has another one (the medium being a CD in this case), and the leaflet containing some print has a third one. There may be also a simple carboard piece lying underneath the transparent lid and containing graphic representation in printed form, and additionally a diffractive element E.

Another example of consumer goods for long term use are various toys which may have packages. A toy itself may be provided with an optical diffractive element E, while another element E is on the package of one or plurality of toys.

As was shown above, a product can be equipped with an optical diffractive element E in either forming it directly on its surface or attaching the element E on a separate carrier, such as label. A hang tag is one further example of a separate carrier that is conventionally used to equip a product with information to the consumer. The hang tag is equivalent to a label in the sense that its is meant to be together with a product and provide information to the consumer at least up to the time of purchase, the difference being merely in the way of attaching to the product. The optical diffractive elements E can be provided on hang tags containing product information from the producer or manufacturer in any graphic representation made by printing. The element E can be formed directly on the hang tag in ways analogical to those described in this disclosure concerning all printed matter. The hang tag is attached to the product in a conventional way, and it can be used on items of clothing, footwear, toys, or any other products that have hang tags for identifying them.

In the case of FIG. 7, at least two elements E can be seen at the same time on the same product A. This can also be applied to cases where there is a package surrounding at least partly its contents, for example one or several products or printed matter. For example the leaflet or other printed matter may be arranged inside the CD casing of FIG. 9 so that the element E is visible through the transparent lid or cover which also contains the element E. In this case the elements E affording the same visual impression both on the package and on its contents can be seen at the same time without opening the package, which helps the verification. The same idea of displaying similar elements simultaneously to the consumer could also be applied in the productpackage combination of FIG. 1 where the element E on the product A could be visible through a transparent window in the package simultaneously with the element E on the package P1. The same idea is also possible in the package of FIG. 3 where at least one, preferably more products A with respective elements E thereon could be visible through a transparent window in the package P1 also containing the element E of same visual impression. In the package of FIG. 8 the elements E are already seen both on the package P1 and on the products A, in this case on the labels on the bottle necks aligned with cuts made in the packaging material, but it is possible that the package is provided with particular openings allowing to see the elements E on the label placed on the body of the bottle or on the bottle itself. “At the same time” or “simultaneously” can be interpreted in the widest sense that both elements E can be seen without a need to open the package, by turning the whole package to see if its has the expected diffraction element on it and if an item inside it is provided with an element of the same visual impression, or preferably so that the both elements E can be seen right on the same side when the package is standing or lying in a retail outlet. Of course, if the packaging material on which the element E is provided, is transparent as such, such as transparent plastic material, any product(s) inside the package and provided with the element(s) E will remain visible also after the packaging.

It is essential for the invention that the element E is present on at least two items, wherein the element E on at least one of the two items is an optical diffraction element based on a physical phenomenon. The following combinations are possible:

A diffraction element E on product A and on a package P1 of the single product (FIG. 1).

A diffraction element E on the package P1 of the single product and on the transport or storage package P2 for these packages P1 (FIG. 2).

A diffraction element E on the product A, on the package P1 for the single product and on the transport or storage package P2 for these packages P1 (FIGS. 1+2).

A diffraction element on the product A and on the transport or storage package P2 for these products A.

A diffraction element E on the product A and on a package P1 containing several such products A (FIG. 3).

A diffraction element E on the package P1 containing several products A and on the transport or storage package P2 for these packages (FIG. 2).

A diffraction element E on the product A, on the package P1 containing several such products A and on the transport or storage package P2 for these packages (FIGS. 3+2).

A diffraction element E on the product A and on a physical carrier material M relating to its distribution or sales, not being a package (FIGS. 1+4 or FIGS. 3+4) A diffraction element E on a package P1 of the single product and on the physical carrier material M relating to the distribution or sales of the product, not being a package (FIGS. 1+4).

A diffraction element E on the package P1 containing several products A and on the physical carrier material M relating to the distribution or sales of the product, not being a package.

A diffraction element E on the product A, on a package P1 of the single product and on the physical carrier material M relating to the distribution or sales of the product, not being a package (FIGS. 1+4).

A diffraction element E on the product A, on a package P1 containing several such products A, and on the physical carrier material M relating to the distribution or sales of the product, not being a package (FIGS. 3+4).

A diffraction element E on the product A and simulation of it in an electronic medium M relating to its distribution or sales (FIGS. 1+5 or FIGS. 3+5).

A diffraction element E on a package P1 of the single product and simualtion of it in the electronic medium M relating to the distribution or sales of the product (FIGS. 1+5).

A diffraction element E on the package P1 containing several products A and simulation of it in the electronic medium M relating to the distribution or sales of the product.

A diffraction element E on the product A, on a package P1 of the single product and simulation of it in the electronic medium M relating to the distribution or sales of the product (FIGS. 1+5).

A diffraction element E on the product A, on a package P1 containing several such products A, and simulation of it in the electronic medium M relating to the distribution or sales of the product (FIGS. 3+5).

Finally, the product A itself may have elements E at least in two different portions thereof which in some manufacturing stage of the product have been put together to form a product ready to sell (FIG. 7). Another material (promotional/informational physical printed matter and/or electronic medium) may optionally be equipped with the element E and/or an effect simulating the element, respectively.

The invention is not limited to the above-mentioned specific examples, but it can be modified within the scope afforded by the enclosed claims. Formation of the diffractive element directly on the substrate by embossing is the most feasible alternative if the products, packages or printed matter are to be produced in large series. Embossing can be also easily integrated in the process where the surface of a substrate is treated, e.g. in a printing process. In some instances it may prove a good alternative or only available alternative to form the element directly on the surface of a product by integrating the formation step in the manufacturing process of the product where the product is given its final shape. The working tool (shim) can be placed for example in a mold, where the product gets its shape and outer surface. This can be applied to blow molding and injection molding for example. It is also possible that the same product contains diffractive elements based on the same phenomenon and giving the same visual easily recognizable effect on different parts, but they are formed in different techniques, depending on the material properties of the part.

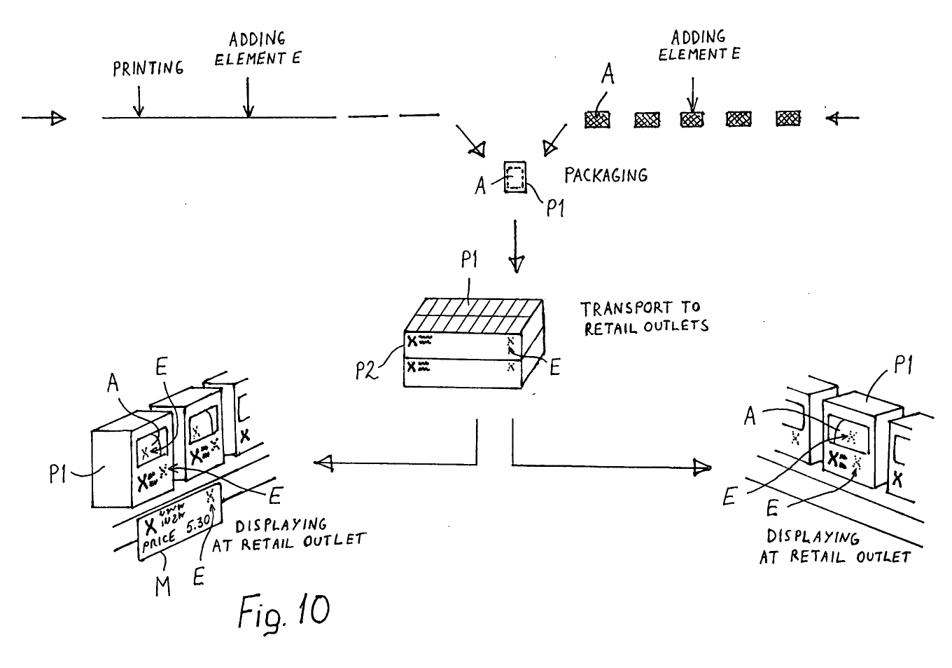

FIG. 10 shows as one example the route of goods from a producer or manufacturer to a retail outlet. Products A (arrow from the right) are made in serial production at production facilities. In some phase of the production optical diffraction elements E are added to the products in either by forming them directly on surfaces of the products or by attaching them to products on separate carriers. Packaging material (arrow from the left) in the form of continuous sheet is printed and elements E are subsequently added preferably directly on the surface of printed material, or on separate carriers. These processing steps are usually made outside the production facilities. The packaging material is supplied to packaging step where the material is cut into blanks, or it can be supplied as pre-cut blanks. In the packaging step the products A are combined with packaging material blanks to form packages P1 in ways which exist in numerous variations and are known per se in the art of packaging technology. The packaging may take place at the production facilities or at a contract packager. Next the packed goods are dispatched in transport packages, optionally also equipped with the optical diffraction elements E, to a plurality of retail outlets, with possible storage steps in between. Finally, the products A and packages P1 are displayed at a retail outlet. On the left-hand side is an example of a promotional material M in the form of product information, more specifically a price tag showing both the product information as ordinary print and the optical diffraction element E preferably directly formed teheron. This price tag is visible near the products A, in this case fixed to a shelf supporting the products. Both the left-hand side and the right-hand side depict how both the element E of the product A inside the package and the element E of the package P1 are visible for consumers at the retail outlet when packages are arranged on a support, such as a shelf, thanks to a transparent window or opening in the opaque or non-transparent packaging material that otherwise would block the sight.

It should be noted that the definition “same visual impression” used in this disclosure does not necessarily mean “of the same size”. The physical sizes of the elements E seen by the public on various locations may differ, but the identifying effect remains the same. Further, depending on choice of substrate, there may be slight differences in the effect. In the impression given by the element, various figures, colors, text matter, any of their combinations, etc, can be used, which may imitate the established trademark of the product or part of it, or be in some other way connected with the producer or manufacturer of the product and thus make it easily identifiable.

It is not excluded either that the element is brought on the surface on a tag or sticker which is designed only for carrying the element, unlike a label discussed above which is used conventionally to contain other information. Small tags or stickers of this kind can be used to attach the optical diffractive element on any location shown above, such as on a product, on a label, on a package, or even on printed promotional matter. However, its is preferable that the formation of the element E is integrated in some treatment step of a product, label, packaging material or printed matter on its way to a finished item without formation of the element on a seprate carrier that has no other functional purpose in the product, label, packaging material or printed matter.

Any other ways of combining the product and diffractive element so that they form an assembly that holds together are possible and are within the scope of the present invention.

The invention is also applicable to other products as those specifically mentioned above. The invention is especially suitable for so-called FMCG (fast moving consumer goods) and CPG (consumer packaged goods). These include foods, candies, beverages, snacks, toys and games, cosmetics, cleaning and hygiene products. However, the invention can be applied also for example in the field of clothing, pharmaceuticals, consumer electronics and entertainment, to mention only some examples.

What is claimed is:

1. A method for specifying products to be sold, comprising:
equipping a plurality of mutually substantially identical products or their packages each with an optical diffraction element of its own, which on separate products or their packages gives the same visual impression; and
equipping also material relating to distribution or sales of the product either
with an optical diffraction element giving the same visual impression as the optical diffraction element on the product or its package, or
with an element simulating this visual impression.

2. The method according to claim 1, wherein the material relating to the distribution or sales of the product is a transport or storage package containing several products.

3. The method according to claim 1, wherein the material relating to the distribution or sales of the product comprises promotion material in the form of an advertisement, product specification, product information, data sheet, or instructions of use relating to the product.

4. The method according to claim 3, wherein said promotion material is present on a physical carrier material

5. The method according to claim 4, wherein the physical carrier material is printed matter.

6. The method according to claim 3, wherein said promotion material is present in electronic or cinematographic media and the element therein simulates the visual impression of the optical diffraction element of the product or its package.

7. The method according to claim 1, wherein equipping the products or their packages comprises forming the optical diffraction element directly on a product or its label, a package material of the product, or a physical carrier material, by processing a surface of the product or its label, material forming a surface of the product, a surface of the package material for the product, or a surface of a physical carrier material.

8. The method according to claim 7, comprising arranging printed indicia in form of alphanumeric data, patterns, figures, emblems, colors, or color combinations, in the same product or its label, package material of the product, or physical carrier material where the optical diffraction element is formed.

9. The method according to claim 8, comprising arranging the printed indicia and the optical diffraction element in relation to each other such that the printed indicia is visible on a different area next to said optical diffraction element on or through the same surface where the optical diffraction element is formed.

10. A system for specifying products to be sold, comprising
several substantially identical products or their packages which are equipped each with an optical diffraction element giving the same visual impression on different products or their packages, the system also comprising
material relating to the distribution or sales of said product and equipped with an optical diffraction element giving the same visual impression as the optical diffraction element of the product or its package, or
material relating to the distribution or sales of said product and equipped with an element simulating this visual impression.

11. The system according to claim 10, wherein the material relating to the distribution or sales of said product is a transport or storage package containing several products.

12. The system according to claim 10, wherein the material relating to the distribution or sales of said product is promotion material in the form of an advertisement, product specification, product information, data sheet or instructions of use relating to the product.

13. The system according to claim 12, wherein the system comprises physical carrier material, on which said promotion material is present in the form of print.

14. The system according to claim 12, wherein the system comprises an electronic or cinematographic medium comprising said promotion material which contains an element arranged in a terminal of the electronic or cinematographic medium to simulate the visual impression of the optical diffraction element of the product or its package.

15. A package comprising at least one item separable from the package, both the item and the package being equipped with optical diffraction elements giving the same visual impression.

16. The package according to claim 15, wherein the package is a package of a single product, the package is equipped with an optical diffraction element, and the product is equipped with an optical diffraction element giving the same visual impression as the optical diffraction element of the package.

17. The package according to claim 15, wherein several products equipped each with an optical diffraction element are packed in a package equipped with an optical diffraction element giving the same visual impression as the optical diffraction elements of the several products.

18. The package according to claim 17, wherein the products are orally administrable.

19. The package according to claim 18, wherein the products orally administrable are pharmaceutical preparations.

20. The package according to claim 17, wherein the products are beverage containers.

21. The package according to claim 15, wherein the optical diffraction element of the item and the optical diffractive element of the package are visible to a viewer outside the package in unopened state.

22. The package according to claim 21, wherein the optical diffraction element of the item is visible through a window or opening formed in a non-transparent packaging material of the package.

23. A product equipped with at least two optical diffraction elements giving the same visual impression in discrete portions of the product.

24. The product according to claim 23, wherein the portions are separable from each other in course of normal use of the product.

25. The product according to claim 23, wherein the portions are permanently attached to each other in course of normal use of the product.

26. The product according to claim 24, wherein the portions are of different materials.

27. The product according to claim 25, wherein the portions are of different materials.

28. The product according to claim 23, wherein the product is a beverage container.

29. A method of helping consumers to recognize authentic products comprising:
providing an authentic product or its package carrying an optical diffraction element, and
providing physical or electronic or cinematographic promotion material of said authentic product, said material displaying a substantially identical optical diffraction element which is selected from the group consisting of a physical optical diffraction element or a simulation of an optical diffraction element.

30. The method as claimed in claim 29, wherein said physical promotion material is selected from the group consisting of printed product information, printed product specifications, printed data sheets, printed brochures, printed posters, printed instructions of use, newspaper advertisements, magazine advertisements, and printed matter displayed in retail outlets where said product is on sale.

31. The method as claimed in claim 29, wherein said electronic or cinematographic promotion material displaying the simulation of the optical diffraction element is selected from the group consisting of material accessible over the Internet, material broadcasted over a TV network, and material displayed cinematographically in a theater.

32. A method of helping consumers to recognize authentic products comprising:
providing an authentic product carrying an optical diffraction element,
packaging one or plurality of said products in a package,
prior to or after packaging, providing said package with an optical diffraction element giving the same visual impression as the optical diffraction element with which the authentic product is provided, and
placing several said packages for sale in a retail outlet so that they can be viewed by consumers visiting the retail outlet.

33. The method according to claim 32, wherein said one or plurality of products are packaged so that the optical diffraction element on the product is visible in the retail outlet together with the optical diffraction element on the package to the consumers without opening the package.

34. A method of helping consumers to recognize authentic products comprising:
equipping an authentic product with at least two optical diffraction elements giving the same visual impression in discrete portions of the product, and
placing several said products for sale in a retail outlet so that they can be viewed by consumers visiting the retail outlet.
